(19) United States
(12) Patent Application Publication
(10) Pub. No.: US 2024/0362579 A1
(43) Pub. Date: Oct. 31, 2024

(54) INTERACTION PREDICTION FOR INVENTORY ASSORTMENT WITH NEARBY LOCATION FEATURES

(71) Applicant: Maplebear Inc. (dba Instacart), San Francisco, CA (US)

(72) Inventors: Haochen Luo, Conroe, TX (US); Kenneth Jason Sanchez, Orange, CA (US); Eric Hermann, San Francisco, CA (US)

(21) Appl. No.: 18/141,393

(22) Filed: Apr. 29, 2023

(51) Int. Cl. G06Q 10/087

(52) U.S. Cl. CPC G06Q 10/087

(57) ABSTRACT

An inventory interaction model predicts user interactions with items of a location for a physical warehouse included with other warehouses in a region. The location is described with features that include the nearby locations and the respective user interactions with the respective item assortments, so that the item interactions for the evaluated location incorporate location-location effects in model predictions. To effectively train the model in the absence of prior interaction data for a location, training examples are generated from existing locations and user interaction data of item assortments by selecting a portion of the locations for the training examples and including nearby location interaction data, labeling the training example output with item interactions for the location. The trained model is then applied for an item assortment at a location by describing nearby locations in evaluating candidate locations and item assortments.

### BACKGROUND

Online concierge systems may facilitate ordering and item fulfillment for users from local physical warehouses. Determining where to place additional warehouses and which items to stock for such warehouses may be a challenging task, particularly when the warehouses are reliant on orders through the online concierge system for timely consuming item stock. Warehouses are limited in physical space available to stock items, and each item may both occupy different amounts of space and be expected to have different demand based on various factors, including other nearby warehouses (and their inventory) and any other items that may be stocked with an item. That is, considering whether and where to add a warehouse and the item assortment to include in that warehouse may be affected by other nearby warehouses and the total assortment of items available. Computer modeling for predicting expected user interactions with items in a warehouse may struggle to effectively predict user interactions with a warehouse, especially for warehouse locations without prior interaction histories (i.e., new warehouses). In addition, while historic user interactions may be available for already-stocked items at existing warehouses, it may be difficult to train a machine-learning model to successfully predict user interactions for warehouses (e.g., a new facility) for which there is no prior history, and to do so with consideration of the other warehouses that may be nearby.

### SUMMARY

In accordance with one or more aspects of the disclosure, training data for a machine-learning model performing inventory interaction prediction is generated based on a set of physical warehouses having user interaction data with the respective item assortment at each warehouse. The interaction data may represent the inventory of each warehouse and the historical user interactions with these items. The machine-learning model predicts user interactions for an item assortment (e.g., one or more items) for a location based on features of the location, the item assortment and features of nearby warehouses, which may include user interaction information for items at the nearby warehouses. To train the model to successfully predict interactions of users with items at a warehouse that does not yet stock items (e.g., there may be no existing item assortment for that location) while benefiting from information about nearby warehouses and their related user interactions, the known user interaction data is used to create training examples for the model.

To create the training examples, a portion of the set of warehouses (i.e., a subset of the physical warehouses) is selected to be training examples for the model. For the selected locations, training examples are generated by considering the other warehouses of the set as the “nearby” warehouses for generation of nearby location features. The training examples may then be labeled with known user interactions of the item assortment for the selected location and used to train the model predictions. For example, data may be available for 100 locations currently stocking items with historical user interactions describing a frequency that users included the respective items from the warehouses in an order from the online concierge system. To generate training data, 10 warehouses may be selected to create training examples, and the remaining 90 warehouses may be evaluated and used to form the nearby location features for each of the ten training examples. The ten training examples may then be labeled with each location's respective user interactions as the output for the model to learn to predict. In some embodiments, the process may be repeated to generate training examples with different subsets of the overall set of locations.

The machine-learning model may then be trained with the training examples to learn parameters for predicting user interactions for an item assortment of a location with consideration of nearby locations and their interactions and item assortments. This provides an effective way for the machine-learning model to simulate the addition of a warehouse to an existing set of warehouses in a region, particularly because the system lacks direct user interaction data for the new warehouse. That is, prediction of users with items in the new warehouse is a “cold start” for model predictions because no data directly exists for user interactions at the new location. This training process provides a way to address this “cold start” problem for the model and determine both potential warehouse locations and evaluate possible item assortments for the locations.

The machine-learning model may then be applied to predict interactions and evaluate a new location with an item assortment, evaluating the effects of adding the location to the existing warehouses in a region. The predicted user interactions for the group of candidate locations may then be used to score the candidate locations and select one to be added as a warehouse in view of the existing locations. The scoring may include consideration of additional factors, such as the available space for a warehouse, the possible item assortment for the warehouse, expense for the warehouse, and so forth.

### BRIEF DESCRIPTION OF THE DRAWINGS

FIG. 1 illustrates an example system environment for an online concierge system, in accordance with one or more embodiments.

FIG. 2 illustrates an example system architecture for an online concierge system, in accordance with one or more embodiments.

FIG. 3 shows an example structure for the inputs and output of an inventory interaction model, in accordance with one or more embodiments.

FIGS. 4A-C show example maps of locations in a region used for an inventory interaction model, in accordance with one or more embodiments.

FIG. 5 shows an example of generating training examples for training an inventory interaction model, in accordance with one or more embodiments.

FIG. 6 shows an example of applying an inventory interaction model 620 to candidate locations, in accordance with one or more embodiments.

FIG. 7 is a flowchart for a method of training an inventory interaction model and using the inventory interaction model for selecting items for an item inventory, in accordance with one or more embodiments.

### DETAILED DESCRIPTION

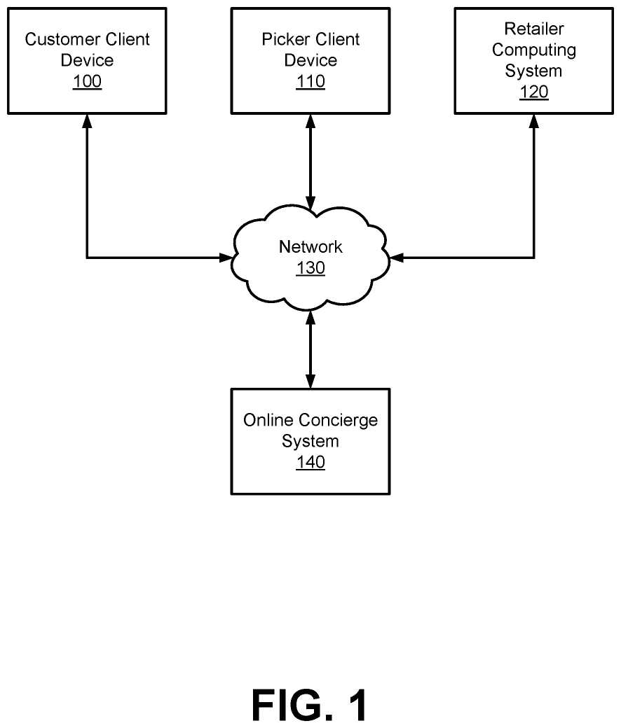

FIG. 1 illustrates an example system environment for an online concierge system 140, in accordance with one or more embodiments. The system environment illustrated in FIG. 1 includes a customer client device 100, a picker client device 110, a retailer computing system 120, a network 130, and an online concierge system 140. Alternative embodiments may include more, fewer, or different components from those illustrated in FIG. 1, and the functionality of each component may be divided between the components differently from the description below. Additionally, each component may perform their respective functionalities in response to a request from a human, or automatically without human intervention.

As used herein, customers, pickers, and retailers may be generically referred to as “users” of the online concierge system 140. Additionally, while one customer client device 100, picker client device 110, and retailer computing system 120 are illustrated in FIG. 1, any number of customers, pickers, and retailers may interact with the online concierge system 140. As such, there may be more than one customer client device 100, picker client device 110, or retailer computing system 120.

The customer client device 100 is a client device through which a customer may interact with the picker client device 110, the retailer computing system 120, or the online concierge system 140. The customer client device 100 can be a personal or mobile computing device, such as a smartphone, a tablet, a laptop computer, or desktop computer. In some embodiments, the customer client device 100 executes a client application that uses an application programming interface (API) to communicate with the online concierge system 140.

A customer uses the customer client device 100 to place an order with the online concierge system 140. An order specifies a set of items to be delivered to the customer. An “item,” as used herein, means a good or product that can be provided to the customer through the online concierge system 140. The order may include item identifiers (e.g., a stock keeping unit (SKU) or a price look-up code) for items to be delivered to the user and may include quantities of the items to be delivered. Additionally, an order may further include a delivery location to which the ordered items are to be delivered and a timeframe during which the items should be delivered. In some embodiments, the order also specifies one or more retailers from which the ordered items should be collected.

The customer client device 100 presents an ordering interface to the customer. The ordering interface is a user interface that the customer can use to place an order with the online concierge system 140. The ordering interface may be part of a client application operating on the customer client device 100. The ordering interface allows the customer to search for items that are available through the online concierge system 140 and the customer can select which items to add to a “shopping list.” A “shopping list,” as used herein, is a tentative set of items that the user has selected for an order but that has not yet been finalized for an order. The ordering interface allows a customer to update the shopping list, e.g., by changing the quantity of items, adding or removing items, or adding instructions for items that specify how the item should be collected.

The customer client device 100 may receive additional content from the online concierge system 140 to present to a customer. For example, the customer client device 100 may receive coupons, recipes, or item suggestions. The customer client device 100 may present the received additional content to the customer as the customer uses the customer client device 100 to place an order (e.g., as part of the ordering interface).

Additionally, the customer client device 100 includes a communication interface that allows the customer to communicate with a picker that is servicing the customer's order. This communication interface allows the user to input a text-based message to transmit to the picker client device 110 via the network 130. The picker client device 110 receives the message from the customer client device 100 and presents the message to the picker. The picker client device 110 also includes a communication interface that allows the picker to communicate with the customer. The picker client device 110 transmits a message provided by the picker to the customer client device 100 via the network 130. In some embodiments, messages sent between the customer client device 100 and the picker client device 110 are transmitted through the online concierge system 140. In addition to text messages, the communication interfaces of the customer client device 100 and the picker client device 110 may allow the customer and the picker to communicate through audio or video communications, such as a phone call, a voice-over-IP call, or a video call.

The picker client device 110 is a client device through which a picker may interact with the customer client device 100, the retailer computing system 120, or the online concierge system 140. The picker client device 110 can be a personal or mobile computing device, such as a smartphone, a tablet, a laptop computer, or desktop computer. In some embodiments, the picker client device 110 executes a client application that uses an application programming interface (API) to communicate with the online concierge system 140.

The picker client device 110 receives orders from the online concierge system 140 for the picker to service. A picker services an order by collecting the items listed in the order from a retailer. The picker client device 110 presents the items that are included in the customer's order to the picker in a collection interface. The collection interface is a user interface that provides information to the picker on which items to collect for a customer's order and the quantities of the items. In some embodiments, the collection interface provides multiple orders from multiple customers for the picker to service at the same time from the same retailer location. The collection interface further presents instructions that the customer may have included related to the collection of items in the order. Additionally, the collection interface may present a location of each item at the retailer, and may even specify a sequence in which the picker should collect the items for improved efficiency in collecting items. In some embodiments, the picker client device 110 transmits to the online concierge system 140 or the customer client device 100 which items the picker has collected in real time as the picker collects the items.

The picker can use the picker client device 110 to keep track of the items that the picker has collected to ensure that the picker collects all of the items for an order. The picker client device 110 may include a barcode scanner that can determine an item identifier encoded in a barcode coupled to an item. The picker client device 110 compares this item identifier to items in the order that the picker is servicing, and if the item identifier corresponds to an item in the order, the picker client device 110 identifies the item as collected. In some embodiments, rather than or in addition to using a barcode scanner, the picker client device 110 captures one or more images of the item and determines the item identifier for the item based on the images. The picker client device 110 may determine the item identifier directly or by transmitting the images to the online concierge system 140. Furthermore, the picker client device 110 determines a weight for items that are priced by weight. The picker client device 110 may prompt the picker to manually input the weight of an item or may communicate with a weighing system in the retailer location to receive the weight of an item.

When the picker has collected all of the items for an order, the picker client device 110 instructs a picker on where to deliver the items for a customer's order. For example, the picker client device 110 displays a delivery location from the order to the picker. The picker client device 110 also provides navigation instructions for the picker to travel from the retailer location to the delivery location. When a picker is servicing more than one order, the picker client device 110 identifies which items should be delivered to which delivery location. The picker client device 110 may provide navigation instructions from the retailer location to each of the delivery locations. The picker client device 110 may receive one or more delivery locations from the online concierge system 140 and may provide the delivery locations to the picker so that the picker can deliver the corresponding one or more orders to those locations. The picker client device 110 may also provide navigation instructions for the picker from the retailer location from which the picker collected the items to the one or more delivery locations.

In some embodiments, the picker client device 110 tracks the location of the picker as the picker delivers orders to delivery locations. The picker client device 110 collects location data and transmits the location data to the online concierge system 140. The online concierge system 140 may transmit the location data to the customer client device 100 for display to the customer, such that the customer can keep track of when their order will be delivered. Additionally, the online concierge system 140 may generate updated navigation instructions for the picker based on the picker's location. For example, if the picker takes a wrong turn while traveling to a delivery location, the online concierge system 140 determines the picker's updated location based on location data from the picker client device 110 and generates updated navigation instructions for the picker based on the updated location.

In one or more embodiments, the picker is a single person who collects items for an order from a retailer location and delivers the order to the delivery location for the order. Alternatively, more than one person may serve the role as a picker for an order. For example, multiple people may collect the items at the retailer location for a single order. Similarly, the person who delivers an order to its delivery location may be different from the person or people who collected the items from the retailer location. In these embodiments, each person may have a picker client device 110 that they can use to interact with the online concierge system 140.

Additionally, while the description herein may primarily refer to pickers as humans, in some embodiments, some or all of the steps taken by the picker may be automated. For example, a semi- or fully-autonomous robot may collect items in a retailer location for an order and an autonomous vehicle may deliver an order to a customer from a retailer location.

The retailer computing system 120 is a computing system operated by a retailer that interacts with the online concierge system 140. As used herein, a “retailer” is an entity that operates a “retailer location,” which is a store, warehouse, or other building from which a picker can collect items. The retailer computing system 120 stores and provides item data to the online concierge system 140 and may regularly update the online concierge system 140 with updated item data. For example, the retailer computing system 120 provides item data indicating which items are available at a particular retailer location and the quantities of those items. Additionally, the retailer computing system 120 may transmit updated item data to the online concierge system 140 when an item is no longer available at the retailer location. Additionally, the retailer computing system 120 may provide the online concierge system 140 with updated item prices, sales, or availabilities. Additionally, the retailer computing system 120 may receive payment information from the online concierge system 140 for orders serviced by the online concierge system 140. Alternatively, the retailer computing system 120 may provide payment to the online concierge system 140 for some portion of the overall cost of a user's order (e.g., as a commission).

The customer client device 100, the picker client device 110, the retailer computing system 120, and the online concierge system 140 can communicate with each other via the network 130. The network 130 is a collection of computing devices that communicate via wired or wireless connections. The network 130 may include one or more local area networks (LANs) or one or more wide area networks (WANs). The network 130, as referred to herein, is an inclusive term that may refer to any or all of standard layers used to describe a physical or virtual network, such as the physical layer, the data link layer, the network layer, the transport layer, the session layer, the presentation layer, and the application layer. The network 130 may include physical media for communicating data from one computing device to another computing device, such as multiprotocol label switching (MPLS) lines, fiber optic cables, cellular connections (e.g., 3G, 4G, or 5G spectra), or satellites. The network 130 also may use networking protocols, such as TCP/IP, HTTP, SSH, SMS, or FTP, to transmit data between computing devices. In some embodiments, the network 130 may include Bluetooth or near-field communication (NFC) technologies or protocols for local communications between computing devices. The network 130 may transmit encrypted or unencrypted data.

The online concierge system 140 is an online system by which customers can order items to be provided to them by a picker from a retailer. The online concierge system 140 receives orders from a customer client device 100 through the network 130. The online concierge system 140 selects a picker to service the customer's order and transmits the order to a picker client device 110 associated with the picker. The picker collects the ordered items from a retailer location and delivers the ordered items to the customer. The online concierge system 140 may charge a customer for the order and provides portions of the payment from the customer to the picker and the retailer.

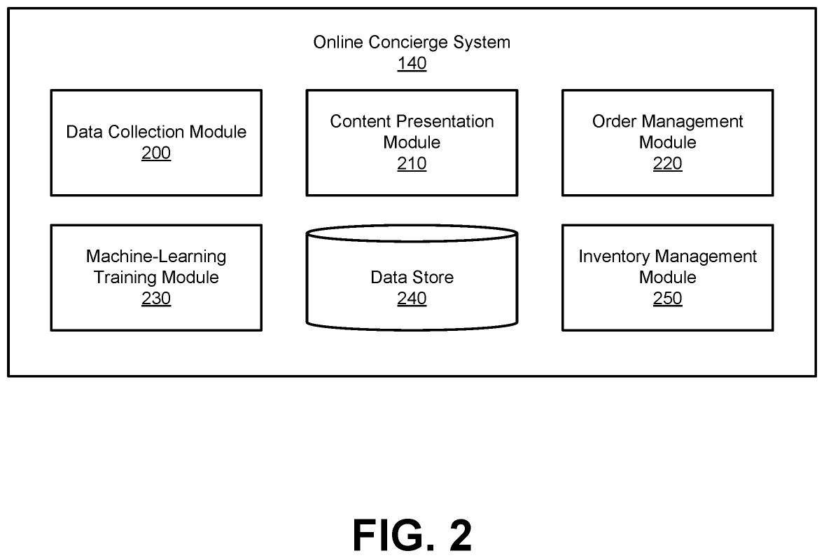

As an example, the online concierge system 140 may allow a customer to order groceries from a grocery store retailer. The customer's order may specify which groceries they want delivered from the grocery store and the quantities of each of the groceries. The customer's client device 100 transmits the customer's order to the online concierge system 140 and the online concierge system 140 selects a picker to travel to the grocery store retailer location to collect the groceries ordered by the customer. Once the picker has collected the groceries ordered by the customer, the picker delivers the groceries to a location transmitted to the picker client device 110 by the online concierge system 140. The online concierge system 140 is described in further detail below with regards to FIG. 2.

FIG. 2 illustrates an example system architecture for an online concierge system 140, in accordance with some embodiments. The system architecture illustrated in FIG. 2 includes a data collection module 200, a content presentation module 210, an order management module 220, a machine-learning training module 230, a data store 240, and an inventory management module 250. Alternative embodiments may include more, fewer, or different components from those illustrated in FIG. 2, and the functionality of each component may be divided between the components differently from the description below. Additionally, each component may perform their respective functionalities in response to a request from a human, or automatically without human intervention.

The data collection module 200 collects data used by the online concierge system 140 and stores the data in the data store 240. The data collection module 200 may only collect data describing a user if the user has previously explicitly consented to the online concierge system 140 collecting data describing the user. Additionally, the data collection module 200 may encrypt all data, including sensitive or personal data, describing users.

For example, the data collection module 200 collects customer data, which is information or data that describe characteristics of a customer. Customer data may include a customer's name, address, shopping preferences, favorite items, or stored payment instruments. The customer data also may include default settings established by the customer, such as a default retailer/retailer location, payment instrument, delivery location, or delivery timeframe. The data collection module 200 may collect the customer data from sensors on the customer client device 100 or based on the customer's interactions with the online concierge system 140.

The data collection module 200 also collects item data, which is information or data that identifies and describes items that are available at a retailer location. The item data may include item identifiers for items that are available and may include quantities of items associated with each item identifier. Additionally, item data may also include attributes of items such as the size, color, weight, stock keeping unit (SKU), or serial number for the item. The item data may further include purchasing rules associated with each item, if they exist. For example, age-restricted items such as alcohol and tobacco are flagged accordingly in the item data. Item data may also include information that is useful for predicting the availability of items in retailer locations. For example, for each item-retailer combination (a particular item at a particular warehouse), the item data may include a time that the item was last found, a time that the item was last not found (a picker looked for the item but could not find it), the rate at which the item is found, or the popularity of the item. The data collection module 200 may collect item data from a retailer computing system 120, a picker client device 110, or the customer client device 100.

An item category is a set of items that are a similar type of item. Items in an item category may be considered to be equivalent to each other or that may be replacements for each other in an order. For example, different brands of sourdough bread may be different items, but these items may be in a “sourdough bread” item category. The item categories may be human-generated and human-populated with items. The item categories also may be generated automatically by the online concierge system 140 (e.g., using a clustering algorithm).

The data collection module 200 also collects picker data, which is information or data that describes characteristics of pickers. For example, the picker data for a picker may include the picker's name, the picker's location, how often the picker has serviced orders for the online concierge system 140, a customer rating for the picker, which retailers the picker has collected items at, or the picker's previous shopping history. Additionally, the picker data may include preferences expressed by the picker, such as their preferred retailers to collect items at, how far they are willing to travel to deliver items to a customer, how many items they are willing to collect at a time, timeframes within which the picker is willing to service orders, or payment information by which the picker is to be paid for servicing orders (e.g., a bank account). The data collection module 200 collects picker data from sensors of the picker client device 110 or from the picker's interactions with the online concierge system 140.

Additionally, the data collection module 200 collects order data, which is information or data that describes characteristics of an order. For example, order data may include item data for items that are included in the order, a delivery location for the order, a customer associated with the order, a retailer location from which the customer wants the ordered items collected, or a timeframe within which the customer wants the order delivered. Order data may further include information describing how the order was serviced, such as which picker serviced the order, when the order was delivered, or a rating that the customer gave the delivery of the order. In some embodiments, the order data includes user data for users associated with the order, such as customer data for a customer who placed the order or picker data for a picker who serviced the order.

The content presentation module 210 selects content for presentation to a customer. For example, the content presentation module 210 selects which items to present to a customer while the customer is placing an order. The content presentation module 210 generates and transmits an ordering interface for the customer to order items. The content presentation module 210 populates the ordering interface with items that the customer may select for adding to their order. In some embodiments, the content presentation module 210 presents a catalog of all items that are available to the customer, which the customer can browse to select items to order. The content presentation module 210 also may identify items that the customer is most likely to order and present those items to the customer. For example, the content presentation module 210 may score items and rank the items based on their scores. The content presentation module 210 displays the items with scores that exceed some threshold (e.g., the top n items or the p percentile of items).

The content presentation module 210 may use an item selection model to score items for presentation to a customer. An item selection model is a machine-learning model that is trained to score items for a customer based on item data for the items and customer data for the customer. For example, the item selection model may be trained to determine a likelihood that the customer will order the item. In some embodiments, the item selection model uses item embeddings describing items and customer embeddings describing customers to score items. These item embeddings and customer embeddings may be generated by separate machine-learning models and may be stored in the data store 240.

In some embodiments, the content presentation module 210 scores items based on a search query received from the customer client device 100. A search query is free text for a word or set of words that indicate items of interest to the customer. The content presentation module 210 scores items based on a relatedness of the items to the search query. For example, the content presentation module 210 may apply natural language processing (NLP) techniques to the text in the search query to generate a search query representation (e.g., an embedding) that represents characteristics of the search query. The content presentation module 210 may use the search query representation to score candidate items for presentation to a customer (e.g., by comparing a search query embedding to an item embedding).

In some embodiments, the content presentation module 210 scores items based on a predicted availability of an item. The content presentation module 210 may use an availability model to predict the availability of an item. An availability model is a machine-learning model that is trained to predict the availability of an item at a particular retailer location. For example, the availability model may be trained to predict a likelihood that an item is available at a retailer location or may predict an estimated number of items that are available at a retailer location. The content presentation module 210 may weight the score for an item based on the predicted availability of the item. Alternatively, the content presentation module 210 may filter out items from presentation to a customer based on whether the predicted availability of the item exceeds a threshold.

The order management module 220 that manages orders for items from customers. The order management module 220 receives orders from a customer client device 100 and assigns the orders to pickers for service based on picker data. For example, the order management module 220 assigns an order to a picker based on the picker's location and the location of the retailer from which the ordered items are to be collected. The order management module 220 may also assign an order to a picker based on how many items are in the order, a vehicle operated by the picker, the delivery location, the picker's preferences on how far to travel to deliver an order, the picker's ratings by customers, or how often a picker agrees to service an order.

In some embodiments, the order management module 220 determines when to assign an order to a picker based on a delivery timeframe requested by the customer with the order. The order management module 220 computes an estimated amount of time that it would take for a picker to collect the items for an order and deliver the ordered items to the delivery location for the order. The order management module 220 assigns the order to a picker at a time such that, if the picker immediately services the order, the picker is likely to deliver the order at a time within the requested timeframe. Thus, when the order management module 220 receives an order, the order management module 220 may delay in assigning the order to a picker if the requested timeframe is far enough in the future (i.e., the picker may be assigned at a later time and is still predicted to meet the requested timeframe).

When the order management module 220 assigns an order to a picker, the order management module 220 transmits the order to the picker client device 110 associated with the picker. The order management module 220 may also transmit navigation instructions from the picker's current location to the retailer location associated with the order. If the order includes items to collect from multiple retailer locations, the order management module 220 identifies the retailer locations to the picker and may also specify a sequence in which the picker should visit the retailer locations.

The order management module 220 may track the location of the picker through the picker client device 110 to determine when the picker arrives at the retailer location. When the picker arrives at the retailer location, the order management module 220 transmits the order to the picker client device 110 for display to the picker. As the picker uses the picker client device 110 to collect items at the retailer location, the order management module 220 receives item identifiers for items that the picker has collected for the order. In some embodiments, the order management module 220 receives images of items from the picker client device 110 and applies computer-vision techniques to the images to identify the items depicted by the images. The order management module 220 may track the progress of the picker as the picker collects items for an order and may transmit progress updates to the customer client device 100 that describe which items have been collected for the customer's order.

In some embodiments, the order management module 220 tracks the location of the picker within the retailer location. The order management module 220 uses sensor data from the picker client device 110 or from sensors in the retailer location to determine the location of the picker in the retailer location. The order management module 220 may transmit, to the picker client device 110, instructions to display a map of the retailer location indicating where in the retailer location the picker is located. Additionally, the order management module 220 may instruct the picker client device 110 to display the locations of items for the picker to collect, and may further display navigation instructions for how the picker can travel from their current location to the location of a next item to collect for an order.

The order management module 220 determines when the picker has collected all of the items for an order. For example, the order management module 220 may receive a message from the picker client device 110 indicating that all of the items for an order have been collected. Alternatively, the order management module 220 may receive item identifiers for items collected by the picker and determine when all of the items in an order have been collected. When the order management module 220 determines that the picker has completed an order, the order management module 220 transmits the delivery location for the order to the picker client device 110. The order management module 220 may also transmit navigation instructions to the picker client device 110 that specify how to travel from the retailer location to the delivery location, or to a subsequent retailer location for further item collection. The order management module 220 tracks the location of the picker as the picker travels to the delivery location for an order and updates the customer with the location of the picker so that the customer can track the progress of the order. In some embodiments, the order management module 220 computes an estimated time of arrival of the picker to the delivery location and provides the estimated time of arrival to the customer.

In some embodiments, the order management module 220 facilitates communication between the customer client device 100 and the picker client device 110. As noted above, a customer may use a customer client device 100 to send a message to the picker client device 110. The order management module 220 receives the message from the customer client device 100 and transmits the message to the picker client device 110 for presentation to the picker. The picker may use the picker client device 110 to send a message to the customer client device 100 in a similar manner.

The order management module 220 coordinates payment by the customer for the order. The order management module 220 uses payment information provided by the customer (e.g., a credit card number or a bank account) to receive payment for the order. In some embodiments, the order management module 220 stores the payment information for use in subsequent orders by the customer. The order management module 220 computes a total cost for the order and charges the customer that cost. The order management module 220 may provide a portion of the total cost to the picker for servicing the order, and another portion of the total cost to the retailer.

The machine-learning training module 230 trains machine-learning models used by the online concierge system 140. The online concierge system 140 may use machine-learning models to perform functionalities described herein. Example machine-learning models include regression models, support vector machines, naïve bayes, decision trees, k nearest neighbors, random forest, boosting algorithms, k-means, hierarchical clustering, and neural networks. Additional examples also include perceptrons, multilayer perceptrons (MLP), convolutional neural networks, recurrent neural networks, sequence-to-sequence models, generative adversarial networks, and transformers. A machine-learning model may include components relating to these different general categories of model, which may be sequenced, layered, or otherwise combined in various configurations.

Each machine-learning model includes a set of parameters. The set of parameters for a machine-learning model are used to process an input and generate an output. For example, a set of parameters for a linear regression model may include weights that are applied to each input variable in the linear combination that comprises the linear regression model. Similarly, the set of parameters for a neural network may include the respective weights and biases that are applied at each neuron in the neural network. The machine-learning training module 230 generates the set of parameters (e.g., the particular values of the parameters) for a machine-learning model by “training” the machine-learning model. Once trained, the machine-learning model uses the set of parameters to transform inputs into outputs.

The machine-learning training module 230 trains a machine-learning model based on a set of training examples. Each training example includes a set of input data for which machine-learning model generates an output. For example, each training example may include customer data, picker data, item data, or order data. In some cases, the training examples also include a label which represents an expected output (i.e., a desired or intended output) of the machine-learning model. In these cases, the machine-learning model is trained by comparing its output from input data of a training example to the label for the training example. In general, during training with labeled data, the set of parameters of the model may be set or adjusted to reduce a difference between the output for the training example (given the current parameters of the model) and the label for the training example.

The machine-learning training module 230 may apply an iterative process to train a machine-learning model, whereby the machine-learning training module 230 updates parameters of the machine-learning model based on each of the set of training examples. The training examples may be processed together, individually, or in batches. To train a machine-learning model based on a training example, the machine-learning training module 230 applies the machine-learning model to the input data in the training example to generate an output with a current set of parameters. The machine-learning training module 230 scores the output from the machine-learning model using a loss function. A loss function is a function that generates a score for the output of the machine-learning model, such that the score is higher when the machine-learning model performs poorly and lower when the machine learning model performs well. In cases where the training example includes a label, the loss function is also based on the label for the training example. Example loss functions include the mean square error function, the mean absolute error, hinge loss function, and the cross entropy loss function. The machine-learning training module 230 updates the set of parameters for the machine-learning model based on the score generated by the loss function. For example, the machine-learning training module 230 may apply gradient descent to update the set of parameters.

The data store 240 stores data used by the online concierge system 140. For example, the data store 240 stores customer data, item data, order data, and picker data for use by the online concierge system 140. The data store 240 also stores trained machine-learning models trained by the machine-learning training module 230. For example, the data store 240 may store the set of parameters for a trained machine-learning model on one or more non-transitory computer-readable media. The data store 240 uses computer-readable media to store data, and may use databases to organize the stored data.

The inventory management module 250 provides inventory management information to retailers and may be used in the management of inventory for physical retailer locations and/or warehouses. Though shown as a component of the online concierge system 140 in FIG. 2, in some embodiments, aspects of the inventory management module 250 may be incorporated in systems used by the retailer in managing physical warehouses/locations that stock items available for purchase and/or for orders coordinated by the online concierge system 140. Each location in which items are stored may have a limited amount of space available and be capable of storing different types of items. For grocery retailers as an example, in addition to different geographical locations, different grocery retailers may have different floorspace available for stocking items, may have different departments or capacities for stocking different items (e.g., one grocer may have no area for frozen items, while another may have an extensive freezer section), may have different clienteles, and so forth. The inventory management module 250 may analyze user interactions, orders, and items to determine predictions for managing inventory at these physical locations. In various embodiments, the inventory management module 250 may provide information relating to warehouse locations, items to stock at these locations and at what quantities, and so forth, to optimize various metrics of the online concierge system 140 and an operator of the warehouse locations.

As one of these functions, the inventory management module 250 recommends placement for a new warehouse or items to be included in a new or existing physical warehouse, such as a retailer's physical location. The collection of items included in the warehouse may also be referred to as the “item assortment” at the warehouse. Determining a location for a new warehouse and an item assortment to include in that warehouse may be particularly challenging because the warehouse lacks existing products and associated user interactions. In addition, the effects of adding a particular warehouse with a particular item assortment may be affected by the other warehouses in the region and the respective items available in that warehouse.

To provide effective modeling of user interactions with an item assortment for a warehouse (or potential new warehouse) while considering the item assortment, the inventory management module 250 trains an inventory interaction model that effectively predicts user interactions for a location (e.g., a candidate location for inclusion with other locations in a region) based on information about the location, the item assortment to be evaluated at that location, and information about nearby locations including user interactions with items at the nearby locations. An example structure, training, and application of the inventory interaction model are discussed below with respect to the following figures.

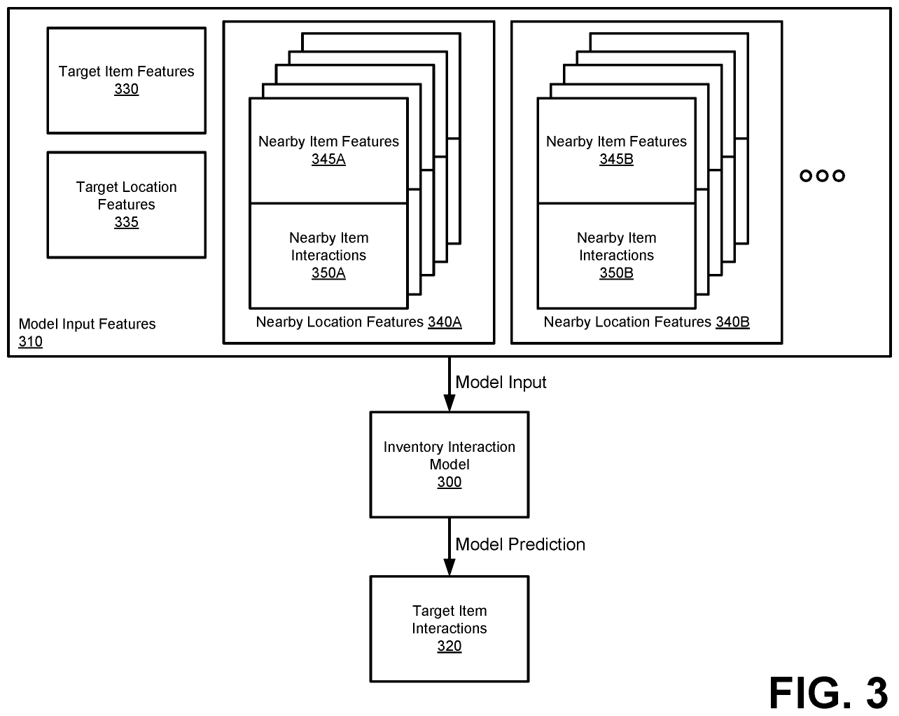

FIG. 3 shows an example structure for the inputs and output of an inventory interaction model 300, in accordance with one or more embodiments. The inventory interaction model 300 receives a set of model input features 310 with respect to a target location having a target item assortment for which to predict one or more target item interactions 320 of users with the target item assortment at the target location. The model input features 310 includes one or more features that may describe the target location, the item assortment to be evaluated for the target location (e.g., one or more items), nearby locations and user interactions, and other features used as inputs to the inventory interaction model 300.

The inventory interaction model 300 is a machine-learning model that includes a number of parameters that together describe the processing of the model input features 310 for the generation of the target item interactions 320. The inventory interaction model 300 may be any suitable type of machine-learning model with trainable parameters, and may include model types as discussed above with respect to the machine-learning training module 230. The inventory interaction model 300 thus may include various types of models and/or layers for various types of processing depending on the particular embodiment and configuration of the inventory interaction model. For example, in one or more embodiments, the model input features 310 may be processed by one or more neural network layers that combine values for preceding layers according to respective parameters, such as weights, biases, and activations. In embodiments in which the target item interactions include more than one predicted interaction for the item assortment of the target location, the inventory interaction model may include multiple output branches, each of which may correspond to a particular output prediction (e.g., one of the target item interactions). In some of these embodiments, the branches may share joint layers (e.g., a common backbone).

The target item interactions 320 may include different types of item interactions in various embodiments and may generally describe a number of predicted interactions by users (e.g., customers) with the item assortment within a particular timespan, such as a day, a week, or a month. The item interactions may be predicted for individual items or for the item assortment as a whole. In one or more embodiments, the predicted target item interactions 320 include a total number of orders by users for the item (e.g., through an online concierge system). Additional types of target item interactions 320 for an item include a number of times the item is added to a shopping list, a total revenue value for orders of the item, total purchases of the item in a physical warehouse (e.g., sales at the physical warehouse that did not originate via the online concierge system), and other ways in which users may interact with the item according to various embodiments. In general, the target item interactions 320 may be used in the determination of an assortment and quantity of items stocked in the warehouse, such that the target item interactions 320 may represent aggregated interactions of users over the timespan, rather than the interactions of any particular users with the items.

To improve predictions particularly for new warehouses or warehouses with limited user interaction data, the model input features 310 may include nearby location features 340 that describe nearby locations to the target location being evaluated. In this example, the nearby location features 340A and nearby location features 340B describe features related to two respective nearby locations. As such, the prediction for the target location may be informed by information about nearby locations improving predictions for the target location's interactions. In this example, the target location is informed by nearby location features 340A-B describing two nearby locations to the target location. In some embodiments, each nearby location may be described with a separate set of nearby location features 340A-B; in other embodiments, information about the nearby locations may be aggregated, consolidated, or otherwise combined to form a single set of nearby location features 340 that describe the group of nearby locations together.

The nearby location features 340 may include various types of features describing nearby locations and user interactions with items at those locations. In this example, nearby item features 345A-B and nearby item interactions 350A-B are shown as example features included in the nearby location features 340A-B. Different configurations and embodiments may include different features describing the nearby location, such as additional features describing nearby locations, such as location information similar to the target location features 335 discussed below. In addition to describing the nearby location itself (e.g., geographic coordinates, user demographics, item assortments, etc.), the nearby location features 340 may include features describing the relative information of the nearby locations with respect to the target location. For example, the nearby location features 340 may include a feature based on a distance between the nearby location and the target location or a relative geographic direction of the nearby location. The nearby location features 340 may thus provide additional location context that may describe the relative geographic location of the nearby locations with respect to the target location whose interactions are predicted.

The target item features 330 may include features determined from information about one or more target items in an item assortment. These features thus describe the item assortment that may be stocked at the target location for which user interactions are predicted. The particular structure of the target item features 330 may vary in different embodiments, and may include one or more item embeddings, categories, types, values, and so forth. In some embodiments, the target item features 330 may be based on one or more machine-learning models that process item information according to respective parameters. In some embodiments, these parameters may be pre-trained or may be trained (or refined) in conjunction with the parameters of the inventory interaction model 300. The target item features 330 may be based on the target item's name, description, categorization, brand, and any other suitable information about the target item. In one or more embodiments, the target item's embedding is based on a natural-language processing of information about the target item, for example by tokenizing a product's description and combining embeddings associated with the respective tokens.

The nearby item feature 345A-B may similarly describe the item assortments of the nearby locations, for example, and may be generated similarly to the generation of the target item features 330. For example, the nearby item features 345A-B may describe each nearby item assortment as an embedding based on information about each item in the item assortment of the nearby locations. In some embodiments, each nearby item may be represented by its own features; in other embodiments, the nearby items may be summarized or aggregated to a feature set describing aspects of the nearby items as a whole. In addition, the nearby items may also be described with features based on the item interactions of the respective items. The nearby item interactions 350A-B may describe the interactions with items at each respective location and may be described for each nearby item or may be an aggregation or summary of the interactions with nearby items at a location. In one example, each nearby location may thus be represented by 1) item features, such as an item embedding, for items at that location, 2) interaction features, such as the number of times these items were included in an order in a relevant timespan, and 3) nearby location features describing the nearby location.

The model input features 310 may include additional features that may vary in different embodiments. For example, the model input features 310 may include target location features 335 that describe the physical location at which the target items are offered. The target location features 335 may describe, for example, the size, capacities, and other properties of the physical location. Additional target location features 335 may also be included, such as characteristics of the local geographical environment (e.g., the climate) of the physical location. Additional target location features 335 that may be included describe the geographic location of the warehouse along with demographic information, such as the relative income levels, typical purchases, and other characteristics of the surrounding clientele of the warehouse. Additional features may also include seasonal or other timing information, or weather, climate, and other data that may affect users' interactions with the item assortment. Various location features describing similar data for the nearby locations may also be included in the nearby location features 340. In some embodiments, the inventory interaction model 300 may be trained with training data across multiple warehouses and across time, such that these factors may also assist in determining item assortments at different locations and at different times at which these various features may differ.

Thus, to evaluate a given item assortment for a given location (e.g., including locations without historical user interaction data), the model input features 310 are determined based on the target location, target item(s) in the item assortment, nearby locations, and other features, and are then input to the inventory interaction model 300. The inventory interaction model 300 is applied to the model input features 310 based on the model's parameters to generate the target item interactions 320. Because the target locations and item assortments in practice may be used as candidates for addition of a new location to a region, the candidate locations and item assortments may not directly have training data describing target item interactions 320 from which the inventory interaction model 300 may be trained to effectively learn parameters. To address this challenge, training examples are constructed based on existing location information, enabling effective training of the model parameters and application of the inventory interaction model 300 to new locations without historical user interaction data.

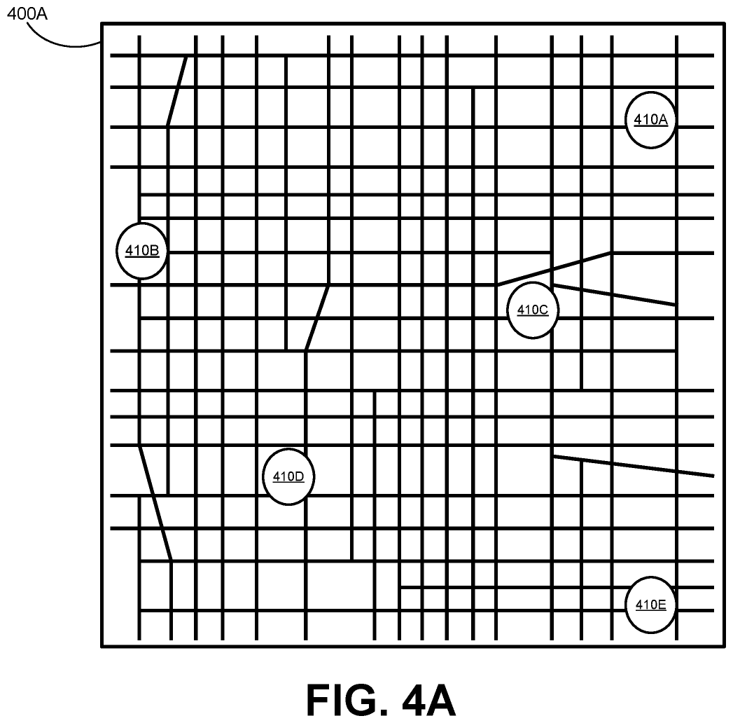

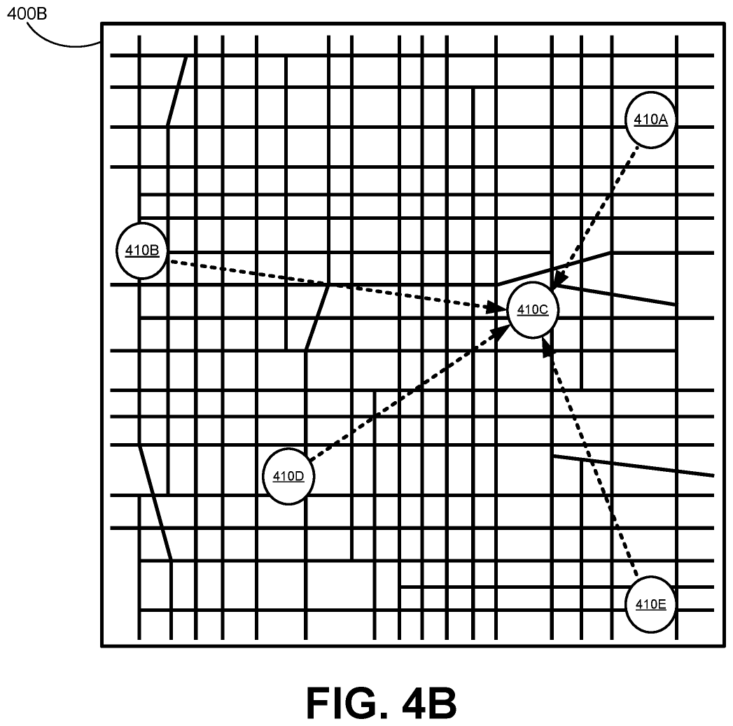

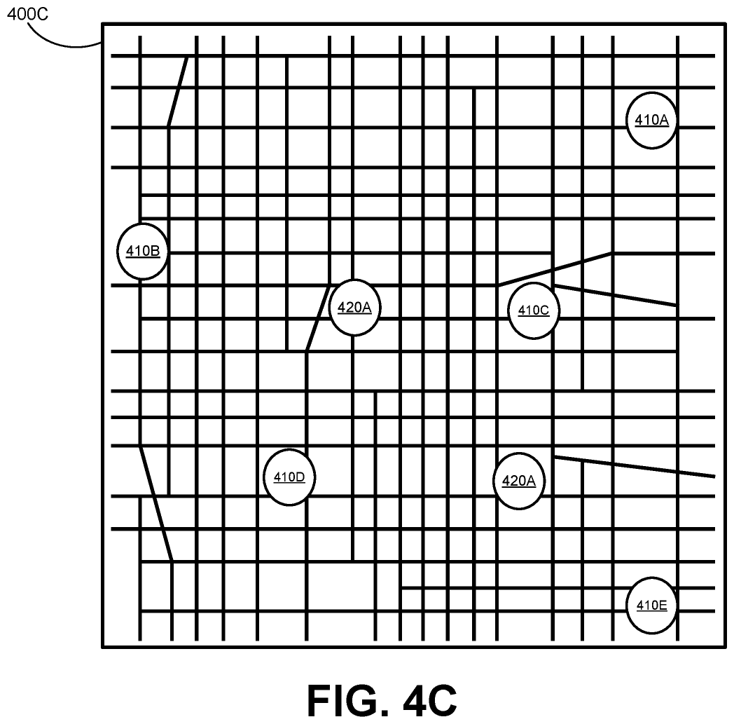

FIGS. 4A-C shows example maps 400A-C of locations 410A-E in a region used for an inventory interaction model, in accordance with one or more embodiments. The locations 410A-E, as shown in map 400A, may correspond to different physical warehouses located in different locations in the region. These warehouses may be located, for example, in different parts of a city or group of cities. The locations 410A-E are examples of physical warehouses that may each stock a respective item assortment and may currently have user interaction data associated with the item assortments. This may represent, for example, the current warehouses using the online concierge system 140.

To generate training data for the inventory interaction model, a warehouse may be selected to form a training example used by the model, with the other nearby warehouses used to generate nearby location features for the selected model. As the example shown in FIG. 4B, location 410C is selected to form a training example (e.g., a set of model input features and a labeled output to be learned), such that the other locations 410A-B, D-E are used to generate nearby location features for the training example. As such, to train the model to make predictions for unknown locations based on nearby locations, the existing user interaction data may be used to generate training data as though an existing location is being added to existing locations in a region. As discussed further below, different locations may be selected as the target location for a training example, so that further training examples may be generated from the user interaction data related to a set of locations. For example, while FIG. 4B shows location 410C as the target location for the training example, additional training examples may be generated by using the other physical warehouses, such as locations 410A-B and D-E as the target locations for additional training examples (in which case, the other locations may be considered nearby locations to generate nearby location features). For example, in one or more embodiments, each location may be considered a training example, such that the training example for each location (i.e., the model input features) uses information about the other locations to generate the nearby location features.

After training the model, the model may then be used to evaluate candidate locations 420A-B as shown in FIG. 4C. That is, to evaluate candidate location 420A and candidate location 420B, information about locations 410A-E may be considered for generating the nearby location feature information in the model input features for these candidate locations. This permits the evaluation of the candidate locations 420A-B by the model to consider the nearby locations and how those locations' item assortments and associated interactions affect predictions for each candidate location. As discussed further below, the user interaction predictions from the model may then be used to evaluate the candidate locations for addition to the current group of nearby locations.

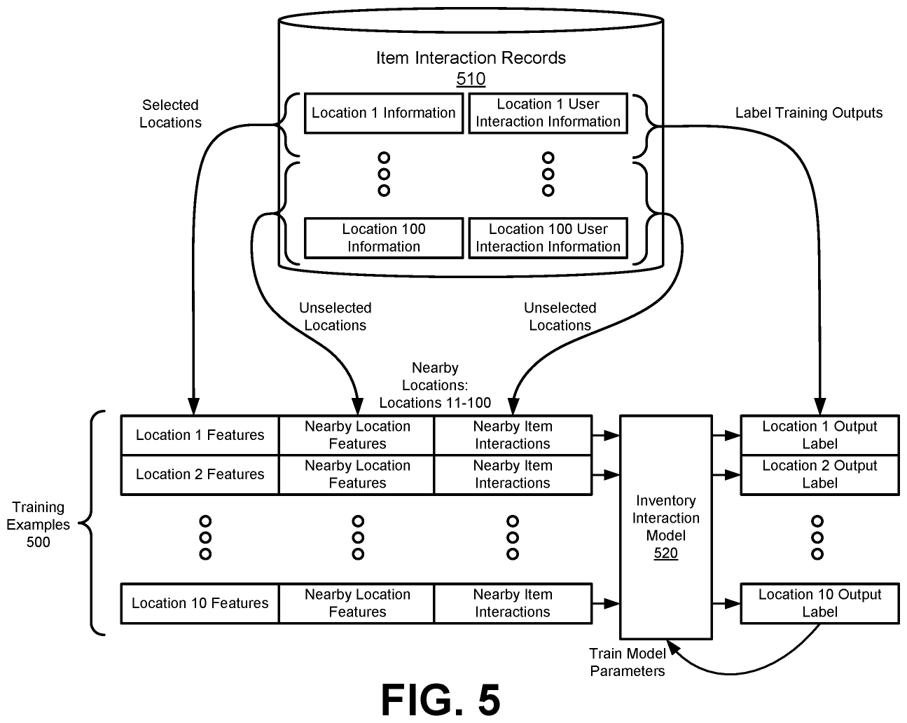

FIG. 5 shows an example of generating training examples for training an inventory interaction model 520, in accordance with one or more embodiments. In this example, a set of training examples 500 is generated based on a set of item interaction records 510. The item interaction records 510 are a set of information about locations, respective item assortments, and user interactions, e.g., for a timespan to be predicted by the inventory interaction model 520. That is, the item interaction records 510 include locations currently used by the online concierge system, items that may have been previously stocked at the locations, and for which the user interactions with respective item assortments are known. As such, the various item assortments, interactions, and nearby locations are known for the locations of a given region.

To form the training examples 500, a portion (e.g., a subset) of the locations are selected to be used as the “target location” for which the model predicts an output. In this example, the first ten locations (location 1 through location 10) are selected to form the training examples 500. Each of the training examples 500 may thus relate to one of the locations, such that location 1 is one training example, location 2 is another training example, and so forth. The locations may be randomly selected or may be selected to be geographically distant from one another (e.g., to avoid selecting locations in a given subset used for training examples that are within a threshold distance from one another).

The model input features for the training examples (i.e., the target location features, item features, nearby location features etc. as shown in FIG. 3) are generated based on information for each respective location, item assortment, and nearby location. As such, the first training example includes location and item features for the first location and its item assortment, and so forth. The remaining locations in the item interaction records 510 (i.e., the items that were not selected as training examples) are then considered as the “nearby” locations for the nearby location features and nearby item interactions for which the training example is evaluated. That is, after removing the selected locations, the remaining item interaction records 510 are processed to generate features for the nearby locations of the training examples, which may include nearby location features describing the nearby location, nearby item features, and interactions with the nearby items. Described another way, the training examples may simulate a circumstance in which the selected locations were not present in the region and each training example is evaluated for addition with the unselected locations. Any additional model input features may also be added according to various embodiments.

In some embodiments, the nearby location features do not include features related to all unselected locations in the item interaction records 510. Rather, depending on the particular target location (e.g., a selected location for the training example 500), the unselected locations may be filtered to select a portion of the locations as the “nearby locations” for the target location based on one or more filters or metrics. For example, the nearby locations may be filtered based on a distance to the target location, such as to include nearby locations within a threshold distance from the target location (e.g., no more than 10 kilometers or miles), a number of closest locations (e.g., the top 5 closest locations), or both (up to five closest locations within 10 kilometers). As such, in some instances the same set of unselected locations may be initially evaluated for the selected locations (the target locations for the set of training examples 500). Then, after application of one or more filters for selecting nearby locations, different groups of locations may be considered as “nearby” for each different training example and used to generate the respective nearby location features for the training examples. As such, for a first training example related to location 1, after applying the filters, the nearby locations may include locations 15, 54, and 80, while for another training example related to location 2, the nearby locations may include locations 13, 32, and 97.

Each training example may then be labeled with a training output based on the user interaction information of the location for its item assortment in the item interaction records 510, such that the model may be trained to minimize an error with respect to each example's training output label (based on the actual user interactions with the item assortment at the target location when near the other nearby locations).

As such, in this example, ten training examples 500 correspond to each of the selected locations 1 through 10, and each set of model input features for the training examples is populated based on nearby location information (e.g., nearby item features and nearby item interactions) based on the unselected locations 11-100 that were not selected as training examples 500. Information related to one or more of the unselected locations may then form the nearby location features for each of the training examples 500. In various configurations, a different number or percentage of locations from the item interaction records 510 may be selected as the training examples 500. For example, the number of locations selected for the training examples 500 may vary. In this example, 10% of the locations were selected and the remaining 90% were used to generate nearby location features; in other configurations, more or fewer locations are selected (as a number or a percentage). In one or more embodiments, a single location is selected as a training example and the remaining locations (in this example, the remaining 99 locations) are used to generate the nearby location features.

In some embodiments, this process is repeated to generate training examples 500 with different subsets of locations in the item interaction records 510. The different subsets may vary the particular locations selected, such that different combinations of locations and nearby locations are used to generate different training examples 500. In some embodiments, the different selected subsets of locations may be mutually exclusive, such that the selected locations in each group of generated training examples do not overlap. For example, a first set of training examples may be generated with locations 1-10, using locations 11-100 as the nearby locations, and a second set of training examples may be generated with locations 11-20, using locations 1-10 and 21-100 as the nearby locations. This may be repeated, in some embodiments, to generate a training example for each location in the item interaction records. For example, a training example is generated for locations 1-10, then locations 11-20, and so forth until a final group of locations 91-100 is selected to generate training examples. In some examples, the same location may be selected for generating a training example with different sets of nearby locations; for example, location 1 may be used to generate a training example with nearby locations 11-100 as one training example, and location 1 may be used to generate a training example with nearby locations 2-90 as another training example.

Finally, the generated training examples 500 are used to train parameters of the inventory interaction model 520 to generate predicted user interactions based on the respective location output labels. That is, the parameters may be trained to reduce an error between the predicted user interactions and the location output label for each training example. The inventory interaction model 520 may be trained with any appropriate machine-learning training approach, such as a gradient descent algorithm and with backpropagation of an error with respect to predicted output(s). In some embodiments, the model may be trained with all training examples as one batch. In other embodiments, the model is trained iteratively with training batches including different training examples. For example, some training examples may be generated (e.g., with selected locations 1-10), the model may be trained based on these training examples as a training batch, and additional training may then be performed (to further refine model parameters) on further-generated training examples. This approach may be used, for example, to generate additional training examples and perform another training iteration based on the performance of the previous training round. In some embodiments, additional training may be performed (i.e., further training examples generated followed by further model training) based on the performance (e.g., accuracy or recall) of the model for the preceding training iteration. Together, this approach allows the item interaction records 510 to be used to create training data and train a model to effectively simulate the addition of a location with an item assortment to a group of existing locations having respective item assortments, despite that actual user interaction data for that location was not used (and may not exist) for training the model.

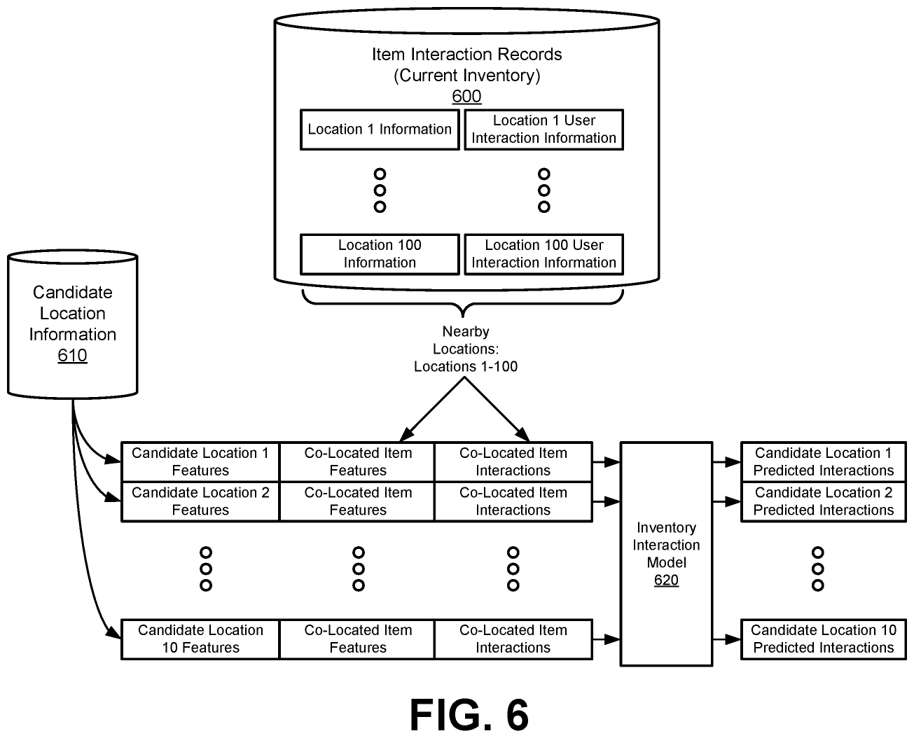

FIG. 6 shows an example of applying an inventory interaction model 620 to candidate locations, in accordance with one or more embodiments. After training, the inventory interaction model 620 may then be used to evaluate a candidate location and one or more items in an item assortment for addition to existing locations by predicting user interactions with the candidate item assortment at the candidate location. The current item assortments of warehouses and user interactions with items are stored as a set of item interaction records 600. The item interaction records 600 may include, for example, the set of items that are currently available at the various locations, and user interactions, such as purchase frequency, associated with the items at each location. In some embodiments, the locations used in the item interaction records 600 are included in the set of locations from which training examples were generated and used to train the inventory interaction model 620. For example, as discussed above with respect to FIGS. 4A-C, the locations 410A-E may be used to generate training data and also used in the evaluation of candidate locations 420A-B as shown in FIG. 4C.

To apply the model, model input features are generated for each of the candidate locations. The model input features include the nearby location features and nearby item features based on the interactions of users with items at the nearby locations (e.g., as stored in the item interaction records 510 as shown in FIG. 5). The nearby locations filtered based on distance to the candidate location as discussed above (e.g., the five closest locations or the locations within a threshold distance) can be used to summarize the current inventory 600 and interactions with users with nearby locations. Features describing each candidate location are included as candidate location features based on a set of candidate location information 610, along with item features for the candidate item assortment for that candidate location and any additional features used as the model input features for the respective candidate locations. The model input features are applied to the parameters of the inventory interaction model 620 to generate respective predicted interactions for the candidate items of the candidate locations. Using the predicted interactions, the items may then be further scored and/or ranked to select locations and items for addition to the existing locations. In some embodiments, the same location may be evaluated with different item assortments to evaluate the likely differences for different item assortments at the candidate location. As such, the inputs to the model may reflect variation in different candidate locations and/or candidate item assortments.

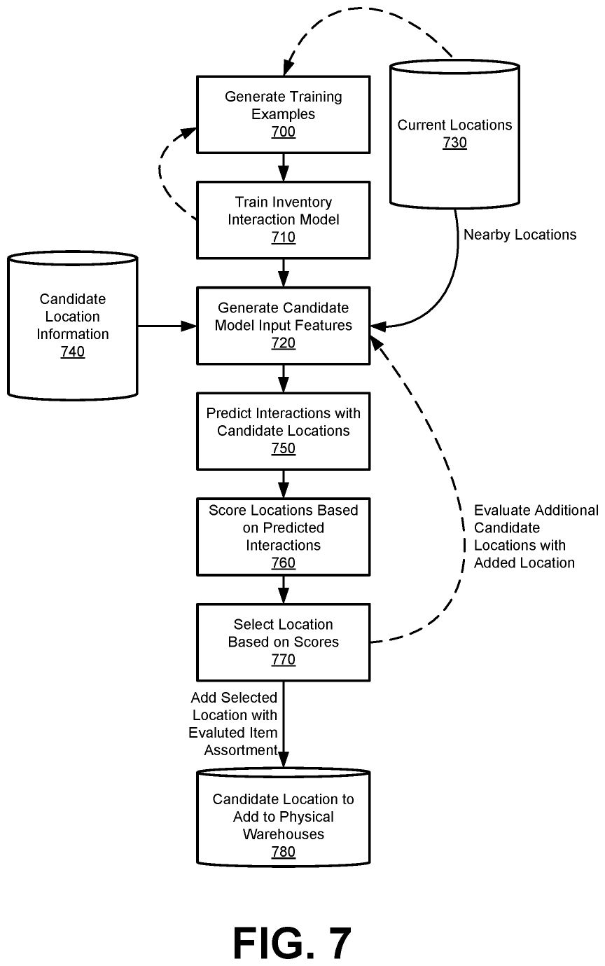

FIG. 7 is a flowchart for a method of training an inventory interaction model and using the inventory interaction model for selecting items for an item inventory, in accordance with one or more embodiments. Alternative embodiments may include more, fewer, or different steps from those illustrated in FIG. 7, and the steps may be performed in a different order from that illustrated in FIG. 7. These steps may be performed by an online concierge system (e.g., online concierge system 140). Additionally, each of these steps may be performed automatically by the online concierge system without human intervention.

Initially, training examples are generated 700 based on item assortments and user interactions with respect to various locations. As discussed above, the training examples may be generated based on current locations 730 and the associated user interactions with respective item assortments. The training examples may be generated 700, for example, by selecting a portion of the locations as the training examples. In some embodiments, the training examples may also include training data and examples from historical location interactions relating to the region at which a candidate location may be added, and further training examples to train the model may also be included from locations related to other regions. Including additional training examples may also assist in preventing the model from overfitting the current region and conditions of a group of locations, while also allowing learning from data of other warehouses and in other conditions (e.g., other item assortments, seasons, other clientele, etc.). The particular training data for a given group of locations and item interactions may be generated as discussed above (e.g., with respect to FIG. 5). That is, each training example may include features of the nearby locations and related interactions for that particular location and its item assortment with associated user interactions. The training examples may then be used to train 710 the inventory interaction model, which may include iterative generation of training examples and further training.

To use the inventory interaction model, nearby locations for a set of candidate locations are identified from candidate location information 740 and current locations 730 to generate candidate model input features 720 as discussed above (e.g., with respect to FIG. 5). In some embodiments, the nearby locations for a particular candidate location may be all locations in a region in which the candidate location will be added (for example, when the candidate location is considered for addition to a current group of locations in a region). In other embodiments, the nearby locations used for evaluation of the candidate locations may be a modification of the current locations in the region. For example, the current locations may be evaluated to determine locations to remove from the region (such as poorly-performing locations), such that the candidate locations are considered for replacement of these poorly-performing locations. As such, the “nearby” locations may represent the locations that will remain in the region after addition of the candidate location, and thus the candidate location is evaluated with respect to these remaining locations as the “nearby” locations used in the model input features for the candidate location.

After the candidate model input features are generated 720, the inventory interaction model is applied to predict 750 interactions with the respective candidate locations with respect to the candidate item assortment. The predictions may include, for example, a number of orders for the item assortment and so forth, according to the particular interactions used to train 710 the inventory interaction model. In some embodiments, the candidate locations may be further scored 760 based on the predicted interactions. For example, in embodiments in which the prediction relates to the number of items ordered by users, the scoring may further evaluate features based on the number of items ordered, such as an amount of warehouse space taken by stock of the items, a total revenue for the item, whether the items have any special requirements to be stocked at the warehouse (e.g., frozen items that require available freezer space), costs for maintaining a warehouse at the candidate location, and so forth. The scoring 760 in some embodiments may thus incorporate these additional factors to determine a total score across which items may be compared.

Using the predicted interactions (and/or scoring), a candidate location may be selected 770 to be added to the physical warehouses (e.g., locations) in a region 780. In some embodiments, the candidate locations may be selected by ranking the candidate locations according to the predicted interactions and/or score, and a number of top-ranked candidate location(s) are selected for addition to the region. In embodiments in which more than one candidate location can be selected for addition to the region, in some configurations, the candidate locations may be selected with iterative evaluation and addition of the locations. This iterative evaluation and addition of locations may be used to account for location-location effects of the candidate locations. That is, the addition of one candidate location to the region may affect the predicted interactions of another candidate location, as locations may constructively or destructively affect interactions at other locations. As such, in some embodiments, one or more locations are selected for addition to the region with associated item assortments. Then, to evaluate further locations, the candidate locations selected for addition are added to the nearby locations for the model input features to re-evaluate other candidate locations. The added candidate locations may be added to the nearby locations with the predicted interactions of the item assortment of that location, such that the nearby location features for further evaluation reflect locations in the region that includes the selected location 770.

### Additional Considerations

The foregoing description of the embodiments has been presented for the purpose of illustration; many modifications and variations are possible while remaining within the principles and teachings of the above description.

Any of the steps, operations, or processes described herein may be performed or implemented with one or more hardware or software modules, alone or in combination with other devices. In some embodiments, a software module is implemented with a computer program product comprising one or more computer-readable media storing computer program code or instructions, which can be executed by a computer processor for performing any or all of the steps, operations, or processes described. In some embodiments, a computer-readable medium comprises one or more computer-readable media that, individually or together, comprise instructions that, when executed by one or more processors, cause the one or more processors to perform, individually or together, the steps of the instructions stored on the one or more computer-readable media. Similarly, a processor comprises one or more processors or processing units that, individually or together, perform the steps of instructions stored on a computer-readable medium.

Embodiments may also relate to a product that is produced by a computing process described herein. Such a product may store information resulting from a computing process, where the information is stored on a non-transitory, tangible computer-readable medium and may include any embodiment of a computer program product or other data combination described herein.

The description herein may describe processes and systems that use machine learning models in the performance of their described functionalities. A “machine-learning model,” as used herein, comprises one or more machine-learning models that perform the described functionality. Machine-learning models may be stored on one or more computer-readable media with a set of weights. These weights are parameters used by the machine-learning model to transform input data received by the model into output data. The weights may be generated through a training process, whereby the machine-learning model is trained based on a set of training examples and labels associated with the training examples. The training process may include: applying the machine-learning model to a training example; comparing an output of the machine-learning model to the label associated with the training example; and updating weights associated for the machine-learning model through a back-propagation process. The weights may be stored on one or more computer-readable media and are used by a system when applying the machine learning model to new data.

The language used in the specification has been principally selected for readability and instructional purposes, and it may not have been selected to narrow the inventive subject matter. It is therefore intended that the scope of the patent rights be limited not by this detailed description, but rather by any claims that issue on an application based hereon.

As used herein, the terms “comprises,” “comprising,” “includes,” “including,” “has,” “having,” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive “or” and not to an exclusive “or.” For example, a condition “A or B” is satisfied by any one of the following: A is true (or present) and B is false (or not present); A is false (or not present) and B is true (or present); and both A and B are true (or present). Similarly, a condition “A, B, or C” is satisfied by any combination of A, B, and C being true (or present). As a not-limiting example, the condition “A, B, or C” is satisfied when A and B are true (or present) and C is false (or not present). Similarly, as another not-limiting example, the condition “A, B, or C” is satisfied when A is true (or present) and B and C are false (or not present).

What is claimed is:

1. A method, performed at a computer system comprising a processor and a computer-readable medium, comprising:
identifying a plurality of user interaction records for items of a plurality of physical warehouses, each physical warehouse having a respective item assortment of one or more items and the user interaction records including interactions with the item assortment of each warehouse;
generating a training data set of training examples by:
selecting a subset of physical warehouses of the plurality of physical warehouses,
for each physical warehouse in the subset of physical warehouses, determining model input features including location features of the physical warehouse and nearby location features, based on interaction data associated with the item assortment, of a portion of the plurality of physical warehouses that excludes the selected subset of physical warehouses,
labeling each physical warehouse in the subset of physical warehouses with output labels based on interaction data of users with the item assortment of the respective physical warehouse, and
including the model input features and the output labels for the subset of physical warehouses as training examples in the training data set;
training a machine-learning model to predict user interactions with an item assortment of a physical warehouse based on the training data set; and
applying the machine-learning model to predict user interactions with a candidate item assortment of a candidate physical warehouse based in part on user interactions with one or more item assortments of one or more nearby physical warehouses.

2. The method of claim 1, wherein the selected subset of physical warehouses is one physical warehouse.

3. The method of claim 1, the method further comprising:
generating additional training examples with a different subset of physical warehouses.

4. The method of claim 1, the method further comprising:
determining the one or more nearby physical warehouses based on a threshold distance to the candidate physical warehouse.

5. The method of claim 1, wherein nearby location features describe relative locations of the nearby physical warehouses.

6. The method of claim 1, wherein the item assortment is based on one or more item embeddings of items in the item assortment.

7. The method of claim 1, wherein the location features describe demographic information.

8. The method of claim 1, wherein the candidate item assortment is one item.

9. A non-transitory computer-readable storage medium having instructions encoded thereon that, when executed by a processor, cause the processor to perform steps comprising:
identifying a plurality of user interaction records for items of a plurality of physical warehouses, each physical warehouse having a respective item assortment of one or more items and the user interaction records including interactions with the item assortment of each warehouse;
generating a training data set of training examples by:
selecting a subset of physical warehouses of the plurality of physical warehouses,
for each physical warehouse in the subset of physical warehouses, determining model input features including location features of the physical warehouse and nearby location features, based on interaction data associated with the item assortment, of a portion of the plurality of physical warehouses that excludes the selected subset of physical warehouses,
labeling each physical warehouse in the subset of physical warehouses with output labels based on interaction data of users with the item assortment of the respective physical warehouse, and
including the model input features and the output labels for the subset of physical warehouses as training examples in the training data set;
training a machine-learning model to predict user interactions with an item assortment of a physical warehouse based on the training data set; and
applying the machine-learning model to predict user interactions with a candidate item assortment of a candidate physical warehouse based in part on user interactions with one or more item assortments of one or more nearby physical warehouses.

10. The non-transitory computer-readable storage medium of claim 9, wherein the selected subset of physical warehouses is one physical warehouse.

11. The non-transitory computer-readable storage medium of claim 9, wherein the computer-readable storage medium further has instructions encoded thereon that, when executed by the processor, cause the processor to perform steps comprising:
generating additional training examples with a different subset of physical warehouses.

12. The non-transitory computer-readable storage medium of claim 9, wherein the computer-readable storage medium further has instructions encoded thereon that, when executed by the processor, cause the processor to perform steps comprising:
generating additional training examples with a different subset of physical warehouses.

13. The non-transitory computer-readable storage medium of claim 9, the instructions further causing the processor to determine the one or more nearby physical warehouses based on a threshold distance to the candidate physical warehouse.

14. The non-transitory computer-readable storage medium of claim 9, wherein nearby location features describe relative locations of the nearby physical warehouses.

15. The non-transitory computer-readable storage medium of claim 9, wherein the item assortment is based on one or more item embeddings of items in the item assortment.

16. The non-transitory computer-readable storage medium of claim 9, wherein the location features describe demographic information.

17. The non-transitory computer-readable storage medium of claim 9, wherein the candidate item assortment is one item.

18. A system comprising:
a processor configured to execute instructions; and
a non-transitory computer-readable medium having instructions encoded thereon that, when executed by the processor, cause the processor to perform steps comprising:
identifying a plurality of user interaction records for items of a plurality of physical warehouses, each physical warehouse having a respective item assortment of one or more items and the user interaction records including interactions with the item assortment of each warehouse;
generating a training data set of training examples by:
selecting a subset of physical warehouses of the plurality of physical warehouses,
for each physical warehouse in the subset of physical warehouses, determining model input features including location features of the physical warehouse and nearby location features, based on interaction data associated with the item assortment, of a portion of the plurality of physical warehouses that excludes the selected subset of physical warehouses,
labeling each physical warehouse in the subset of physical warehouses with output labels based on interaction data of users with the item assortment of the respective physical warehouse, and
including the model input features and the output labels for the subset of physical warehouses as training examples in the training data set;
training a machine-learning model to predict user interactions with an item assortment of a physical warehouse based on the training data set; and
applying the machine-learning model to predict user interactions with a candidate item assortment of a candidate physical warehouse based in part on user interactions with one or more item assortments of one or more nearby physical warehouses.

19. The system of claim 18, wherein the selected subset of physical warehouses is one physical warehouse.

20. The system of claim 18, wherein the non-transitory computer-readable medium further has instructions encoded thereon that, when executed by the processor, cause the processor to perform steps comprising:
generating additional training examples with a different subset of physical warehouses.
